(19) United States
(12) Patent Application Publication
(10) Pub. No.: US 2003/0006897 A1
(43) Pub. Date: Jan. 9, 2003

(54) Vehicular alert apparatus and methods having variable characteristics

(76) Inventors: Stephen T. Chapin, New York, NY (US); Arthur R. Leary, West Roxbury, MA (US)

Correspondence Address: LAHIVE & COCKFIELD, 28 STATE STREET, BOSTON, MA, 02109, US

(21) Appl. No.: 10/136,099

(22) Filed: Apr. 29, 2002

Related U.S. Application Data
(60) Provisional application No. 60/287,063, filed on Apr. 27, 2001.

(51) Int. Cl. B60Q 1/54

(52) U.S. Cl. 340/466; 340/425.5; 340/388.1

(57) ABSTRACT

An alert apparatus for use with a vehicle is provided having a horn capable of producing a sound and a first sensor adapted to determine a speed of the vehicle. A controller is coupled to the first sensor and the horn and adapted to activate the horn such that characteristics of the sound are determined based on the speed. A horn switch may also be coupled to the controller to activate the horn upon application of a force by an operator. A method of operating a vehicle horn is also provided. According to the method, an output is obtained from a sensor representative of a speed of a vehicle. The output is processed by the use of a controller to determine a desired horn characteristic, and the vehicle horn is activated to produce the desired horn characteristic.

### REFERENCE TO RELATED APPLICATIONS

The present invention claims priority to a U.S. Provisional Patent Application, Serial No. 60/287,063, filed Apr. 27, 2001, entitled Speed Determined, Variable-Volume Vehicular Horn. Provisional Patent Application Serial No. 60/287,063 is hereby incorporated by reference.

### BACKGROUND OF THE INVENTION

The horn now used by cars, small trucks, and motorcycles is essentially the same today as it was in the days immediately following World War II. It consists of several discordant tones set at a volume determined by compromise. This single volume should not be so loud that it terrifies pedestrians in stopped city traffic, but it must be loud enough that it can be heard at speed on the highway when another driver is unaware of your existence. This horn, with its origins in the forties, is fine for steady cruising between 25 and 45 mph on relatively empty roads, and it worked well when there were fewer cars, fewer expressways, and much less congestion. It is, however, inadequate for current conditions.

### SUMMARY OF THE INVENTION

Speed limits, as well as the higher actual speeds maintained on the highway, have increased. Traffic density has intensified to the point where you often find yourself on a four lane divided highway moving in excess of 70 mph while packed in between a car 20 feet behind, another the same distance in front, and a solid lane next to you. Also, designed into almost all new cars, trucks and SUVs are many new, attention-diverting devices, such as cell phones, high-end sound systems, and computer navigation screens. Air-conditioning has become ubiquitous, allowing the windows to be closed at all times. Even with the windows closed, road noise due to wind and tires at highway speeds leads most drivers to increase the volume of their music systems or radios to ensure clear sound above the highway din. In this new world of more aurally-isolated drivers moving faster and closer together, a good vehicle horn is increasingly necessary for survival. However, most horns sound weak at these speeds, and there is no assurance that yours will be loud enough to be heard by neighboring drivers. Often you are not sure that you have heard someone else's horn.

The vintage World War II horn also causes problems at the other end of the speed range. With the vastly increased volume of traffic, it has become much more common to be in stopped or slowly-moving traffic. It is a normal human reaction to these conditions to blow your car's horn. Pedestrians, bicyclists, and residents of heavily traveled streets in cities and the denser suburbs can attest to the fact that each rush hour, lasting 2 or 3 hours, is a cacophony of honks, and that their quality of life suffers as a result. Under these conditions a softer, less abrasive horn can provide the needed alert without fouling the aural environment.

Motorcycles, being smaller than cars and trucks and sometimes maneuvering more quickly, are often unseen by other drivers on a highway. Most motorcycles are not presently equipped with horns as loud as those fitted to passenger cars. The motorcycle rider is the most vulnerable person on the freeway, yet has the most inadequate horn warning system on the road.

Given these new road conditions, the vehicular horn would become a far more effective instrument in fulfilling its various functions if it could be freed from the necessity of producing only one sound at only one loudness. The present invention recognizes that louder, more discernible horns improve safety in high-speed traffic environments. Also, the present invention recognizes that if the noise created by horns were reduced somewhat in stopped or low speed traffic, life in highly populated areas would become much more bearable.

In one embodiment, the invention involves varying a characteristic of the horn, such as loudness, in relation to vehicle speed. For example, the loudness of the horn could be lower than that of a standard horn when stopped or moving slowly, and higher than that of a standard horn when moving at highway speed. In other embodiments, the invention involves various adjustments to the attributes of the horn in relation to vehicle speed, duration of actuation, and pressure of actuation. Other embodiments of the invention take advantage of vehicle sensor data which is likely to become available and standard in the near future.

Other embodiments of the invention employ sensing and information processing techniques, which have become readily available and affordable, for the purpose of adapting the performance of the horn to the widely varying circumstances of its uses. The car horn needs no longer to be a functionally “one size fits all” device; using straightforward decision-making processes it can range from environment-friendly alerts to unmistakable crisis warnings under emergency conditions. According to one embodiment, the inputs to the processing decision are vehicle speed, along with other sources of sensing data as they become available, duration of horn activation, pressure of the driver's hand on the horn actuator, or a combination of these inputs. The resulting possible horn outputs range from a gentle tone for a polite signal at low speed to extra-loud, multi-tone bursts of sound in an emergency situation.

According to one embodiment, an alert apparatus for use with a vehicle is provided, having a horn capable of producing a sound and a first sensor adapted to determine a speed of the vehicle. A controller is coupled to the first sensor and the horn and adapted to activate the horn such that characteristics of the sound are determined based on the speed.

According to another embodiment, an alert apparatus for use with a vehicle is provided with a horn capable of producing a sound and a horn switch adapted to be operated by a force applied by an operator of the vehicle. A sensor is adapted to determine an amount of the force, and a controller is coupled to the sensor, the horn switch and the horn and adapted to activate the horn such that characteristics of the sound are determined based on the force.

A further embodiment of the invention provides a method of operating a vehicle horn. An output is obtained from a sensor representative of a speed of a vehicle. The output is processed by the use of a controller to determine a desired horn characteristic, and the vehicle horn is activated to produce the desired horn characteristic.

### BRIEF DESCRIPTION OF THE DRAWINGS

The invention will be apparent from the description herein and the accompanying drawings.

FIG. 1 is a block diagram illustrating various alternatives according to an embodiment of the invention;

FIG. 2 is a block diagram illustrating an apparatus according to an embodiment of the invention; and

FIGS. 3-14 illustrate examples of various graphs of horn loudness in relation to vehicle speed according to embodiments of the invention.

### DETAILED DESCRIPTION

The human ear can cover an amazing range of sound levels. The ratio of sound pressure at the pain level to the sound pressure level at the threshold of perception is more than 1,000,000:1 in a person with good hearing. For convenience, this large dynamic range is customarily described by a logarithmic scale based on the lowest sound pressure perceptible by a human with acute hearing. This pressure level is 20 micro-Pascal and is set to be 0 decibels (0 dB) on the logarithmic scale. In addition, the sound levels are scaled to match the shape of the human ear's response over the spectrum of sound frequencies (tones). This scale is referred to as dB(A). Representative sound pressure levels are 30 dB(A) for a soft whisper, 40 dB(A) in a library, 60 dB(A) in an office with air conditioning ducts, 80 dB(A) for a noisy restaurant, 90 dB(A) for a heavy truck, 100 dB(A) as a state limit for motorcycle noise, 110 dB(A) for a typical automobile horn, 120 dB(A) for a rock concert, 125 dB(A) for an automobile stereo at full volume, 130 dB(A) for a truck's roof-mounted horn, 150 dB(A) for a jet aircraft taking off, and 180 dB(A) for a rocket launch. 140 dB(A) is usually considered painfully loud.

An increase of 6 dB(A) represents a doubling of sound pressure, but this does not mean a doubling of “loudness”. Perceptual biophysics add some complexity to these relations, levels vary from person to person, and rules of thumb are determined empirically. A change of 1 dB(A) may be perceptible to someone with acute hearing. A change of 3 dB(A) is noticeable by most people. However, it takes a change of 10 dB(A) for most people to perceive an increased sound level as being “twice as loud”. An accepted approximation is that every increase of 10 dB(A) means a doubling of perceived loudness. Thus, a sound increasing from 70 dB(A) to 90 dB(A) would seem four times as loud, and a sound increasing from 70 dB(A) to 100 dB(A) would seem eight times as loud.

However, the effects of seemingly large increases can be dissipated. Like many types of geometrical energy propagation, sound power from a localized source spreads out spherically, so that perceived loudness decreases with distance. Thus, in a high speed situation when a vehicle should be separated from another vehicle by a longer and safer distance, a sound at 30 meters distance will seem only half as loud as the same sound from 10 meters distance in lower speed traffic. The description of this in the dB(A) scale is that for a tripling of distance there is a decrease of 10 dB(A) in sound pressure level, which produces a factor-of-2 drop in perceived loudness. Compounding this loss of loudness is the attenuation of sound by the car itself.

Auto makers have succeeded in making the interiors of cars quiet and pleasant by blocking out road noise, wind noise, and other exterior noise with increasing efficiency. Most vehicles now have elaborate climate control systems available, requiring that the windows be closed at all times. The noise attenuation of modem cars with closed windows is more than 20 dB(A). Thus, if a driver in city traffic has his windows open and is suitably alerted by a standard horn at 10 m distance, that same horn on a freeway at 30 m distance with windows closed will sound weaker by 10 dB(A) for the distance plus 20 dB(A) due to the windows. This totals 30 dB(A), which will make the horn sound less loud by a factor of 8. Add to this the masking noise of a car stereo, cell phone, or loud children in the car, and it is clear that one simple level of horn performance cannot be optimal for these extremes of conditions. In fact, the audibility situation can be so extreme that ambulance drivers assume that 90% of their sensory warning must be by means of lights, even in daylight, and in some noisy urban intersections they can assume siren penetration of a driver's attention to a distance of only 12 m in front of them. The variety of acoustical and speed conditions required in the operation of today's vehicles demands implementation of a horn system which automatically varies horn output based on logical processing of data from the vehicle and inputs from the driver.

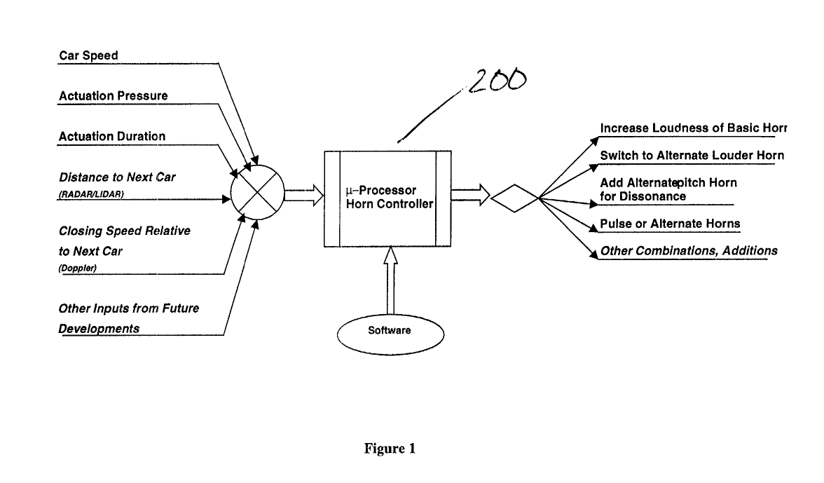

In one embodiment, the invention relies on the flexibility and processing power of the microprocessor. The embodiment alters the operation of a vehicle's horns based on various inputs from the driver and sensing devices in the vehicle. See FIG. 1. The basic architecture of the system can be adapted according to the availability of sensor inputs and the type of horn hardware chosen for the particular vehicle concept. Parameters can be optimized for each variant during the software development stage of the product, and these parameters can furthermore be changed and refined after initial manufacture, for example, during an upgrade or recall process at the facility of an authorized service center.

The inputs include attributes which are easily obtainable with today's hardware. Car speed information can be converted from analog speedometer signals, and in many cars the speed information is already in digital format for display on numerical dashboards. Pressure transducers can easily be incorporated into horn controls to sense the actuation pressure, and the duration of actuation can be measured simply by having the horn controller count processing clock cycles while the horn control is actuated. Each of the inputs in italics show functionality according to various alternative embodiments of the invention. Both radio- and laser-based ranging schemes may be used to provide instant and continuous monitoring of the distance to the car in front. Similarly, Doppler techniques adapted from law enforcement radar speed guns may be used to provide alerts in the case of dangerously high closing speeds with respect the car in front. These and other yet-to-be-developed sources of car status can be added to the information available to the horn controller to determine the optimal employment of horn assets. Each of the inputs shown in FIG. 1 may be used alone or in combination with other inputs.

The output decisions vary depending on the amount and complexity of the horn hardware chosen. The result can be a gradually increasing drive of a single electric horn as speed increases. The decision can be to switch at a certain speed to an alternate, air-driven horn of increased loudness if there is room and budget to package this horn in the car. Another approach is to add a second horn of loudness similar to the basic horn, but set at a pitch which generates annoying and attention-getting dissonance with respect to the first horn. Also well-known is the jarring effect of alternating or pulsing the two dissonant tones from two horns. Each of the outputs shown in FIG. 1 may be used alone or in combination with other outputs. According to the invention, there are many permutations of these techniques of varying horn output as a function of situational conditions based on intelligent and automatic data processing.

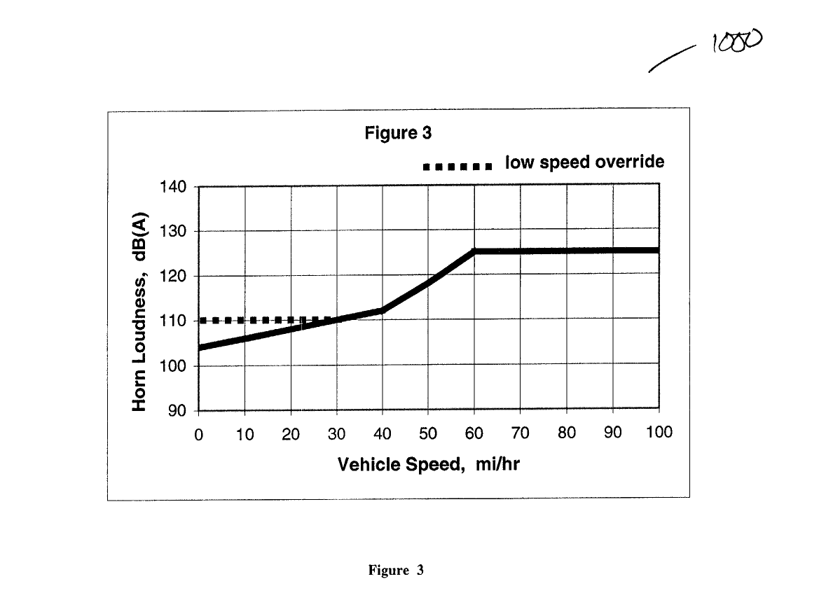

Examples of embodiments of this invention follow in the description of graphs illustrating examples of various possibilities. See FIGS. 3-14. These examples are meant to be illustrative and not limiting. The present invention has been described by way of example, and modifications and variations of the exemplary embodiments will suggest themselves to those of skill in the art without departure from the spirit of the invention. Features and characteristics of the described embodiments may be used in combination. The described embodiments are merely illustrative and should not be considered restrictive in any way.

The graphs are drawn on two axes; the vertical axis represents the horn loudness measured in decibels, normalized to the typical human aural spectrum in dB(A), and the horizontal axis represents the vehicle speed in miles per hour. All of the various embodiments of the invention depicted in the graphs show a lower sound level at slower speeds and a higher level at faster speeds.

Slanted lines in the graphs indicate a smoothly varying change of loudness, analogous to the function of a potentiometer or rheostat, as the speed of the vehicle changes. Steeper sloping lines in the graphs indicate a faster rate of change in loudness, while slopes closer to horizontal indicate a more gradual rate of change.

The horizontal lines in the graphs represent a horn at constant loudness. Vertical line segments indicate an abrupt change in the loudness of a horn commanded at a specific speed by a step change in the horn's actuation, for instance by means of electrical current or air pressure. Step changes in loudness can also be achieved by sequentially adding in one or more additional horns at specific speeds. Horns of differing tones, chosen to produce a dissonant, jarring combination of sounds, can be added in abruptly, or with loudness gradually increasing with speed. These horns with differing tones are shown in the graphs by means of lines with embedded geometric markers. Most of the graphs depict illustrative combinations of devices and methods.

All the graphs show a loudness at slower speeds which is less than the typical 110 dB(A) of today's standard horn, although the invention is not so limited. The invention provides this capability in order to reduce noise pollution in slow speed urban settings where moderate horn loudness suffices. However, there can be occasions when a loud alert is needed even at a standstill, for instance to warn a pedestrian of danger coming from the other direction. To encompass such needs, according to one embodiment, software can be tailored to allow an override of the normal slow-speed loudness; this can be by means of a pressure-sensitive horn control. At normal hand pressure at slow speed, the lower loudness levels shown in the graphs would be produced. With stronger pressure applied in an emergency, the horn would revert to a higher level of the designer's choosing, probably 110 dB(A), regardless of the slow vehicle speed. A short delay in the processor's reaction to subsequently changing commands, programmed by the designer, would prevent any mischievous toggling back and forth between volumes.

If a pressure-sensitive control is not feasible or affordable in a particular application of the invention, then, according to one embodiment, this same function can be provided by measuring the duration of the activation of the horn. Most horn toots last for less than one second. The duration of the command can always be easily measured in a microprocessor-based system simply by having the software count clock cycles during the activation. A duration can be chosen beyond which the system will consider the situation to be an emergency and revert to the higher level of loudness, despite the slow speed. Similarly, the system could be programmed to allow early transition to very loud output at higher speed based on activation hand pressure (or duration), or the combination of both pressure and high speed could be required to allow the loudest or most abrasive sounds.

The loudness of a typical present-day auto horn is 110 dB(A). It is shown on FIGS. 3-14 as a dashed line existing below a set speed in the 15 mi/hr to 40 mi/hr range. It represents the second option, that of using higher hand activation pressure when the vehicle is equipped with a pressure-sensitive switch to produce a louder alert in an emergency situation at slow speeds.

FIGS. 3-14 are illustrative of implementations of the present invention. The examples are by no means exhaustive or limiting. Sensing vehicle speed, the duration of a switch activation, and the pressure applied during a switch activation are examples of inputs.

FIG. 1 illustrates, by way of example, the use of measurement of the range to the next vehicle ahead and the speed differential of that vehicle with respect to the driver's vehicle as potentially useful input to the horn controller decision-making process.

FIG. 1 illustrates a microprocessor-based horn controller. The processor decides upon horn output based on analysis of the driver's commands, the speed of the car, and the car's situation relative to other traffic. The inputs represent information available with current equipment and information expected to be available soon as advanced technologies transition to the commercial marketplace. The decision making process may be provided by a controller operating software. This software may optionally be revised and upgraded at any time, if desired.

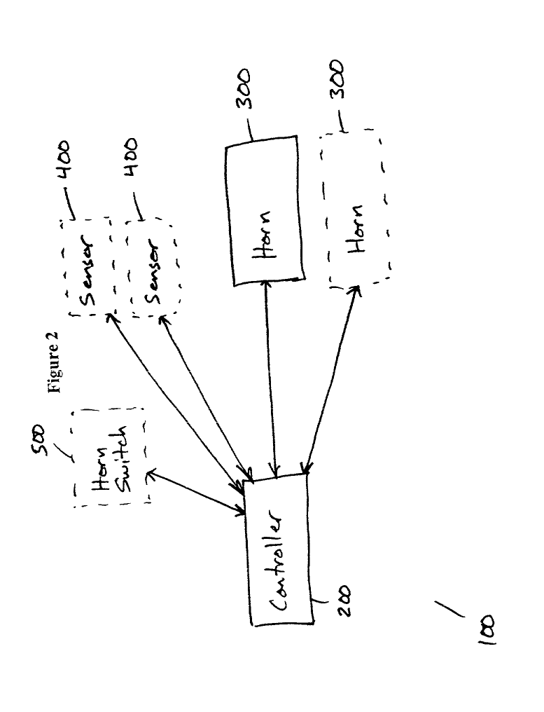

FIG. 2 illustrates an alert apparatus 100 according to an embodiment of the invention. A controller 200 is provided. The controller 200 is adapted to execute instructions, such as those provided by software, firmware or a combination thereof. The controller 200 is coupled to at least one horn 300 such that the controller 200 can activate one or more horns 300 as desired. The horn 300 may be adapted to provide outputs having a variety of characteristics. Examples of horn characteristics include varying loudness or tone and other characteristics illustrated in FIG. 1. At least one sensor 400 is also coupled to the controller 200. The sensor 400 may be adapted to output a speed of the vehicle, distances or closing speeds to other vehicles. A horn switch 500 may also be coupled to the controller 200 so that an operator may send a signal to the controller 200 to activate the one or more horns 300. The horn switch 500 may also optionally provide information to controller 200 corresponding to an actuation force used by the operator to depress the horn switch 500. The controller 200 may also obtain inputs and activate the one or more horns 300 according to any one of the many variations illustrated in FIG. 1. Each of the inputs shown in FIG. 1 may be used alone or in combination with other inputs. Likewise, each of the outputs shown in FIG. 1 may be used alone or in combination with other outputs.

FIG. 3 illustrates a graph 1000 showing the operation of an embodiment of the invention involving adjustment to horn loudness at two different rates relative to the speed of a vehicle. The loudness increases more steeply at higher speeds due to the need for longer stopping distances and the geometric spread of sound energy. The function levels off at the practical limit of chosen horn hardware and actuating energy availability. This might be in the range of 125 dB(A) for a high-capacity 12 VDC single horn. Other appropriate specific levels of loudness and speed may be used.

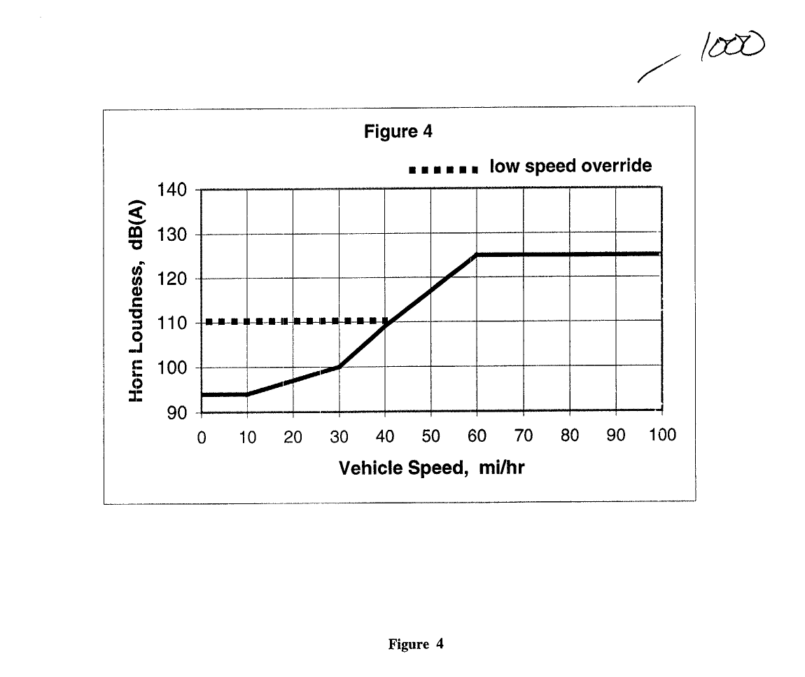

FIG. 4 illustrates a graph 1000 showing the operation of an embodiment of the invention involving adjustment to horn volume at three different rates relative to the speed of a vehicle. This embodiment allows for a gentler sound when stationary or traveling at slow speeds in traffic, while ramping up to the same levels at higher speeds as in FIG. 3.

Under normal circumstances of slow speed in traffic, the level could be an environment-friendly and polite 94 dB(A). However, to account for situations where the driver perceives a major risk and needs to give a louder alert, the horn controller would react to heavy pressure on the horn control, extended duration of actuation, or a combination of these to raise the level to perhaps 110 dB(A) as shown by the dashed line, which would certainly attract attention in a congested location. A time delay of 1 or 2 seconds or more could be programmed into the software to prevent toggling back and forth between these levels just to create a nuisance.

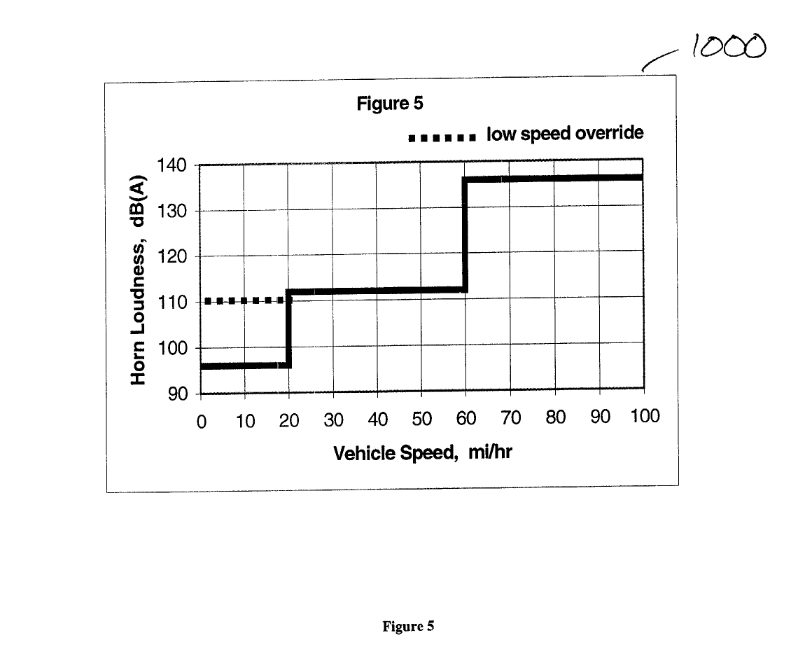

FIG. 5 demonstrates a graph 1000 showing the operation of a further embodiment of the invention having a relationship of horn loudness to vehicle speed involving a constant horn volume within each of three vehicle speed ranges. This would facilitate an implementation where analog control of horn loudness might not be available, but several horns, such as air horns, each with a discreet, constant loudness level, were installed. Hysteresis could be implemented in the control scheme to ensure that loudness levels did not toggle back and forth as the vehicle drove at or near one of the transition speeds. As in the case of FIG. 4, emergency override capability at slow speeds could be provided based on pressure and/or duration of activation. The 136 dB(A) shown for high speed could be achieved by means of a strong trumpet air horn with a small compressor and plenum as a possibility.

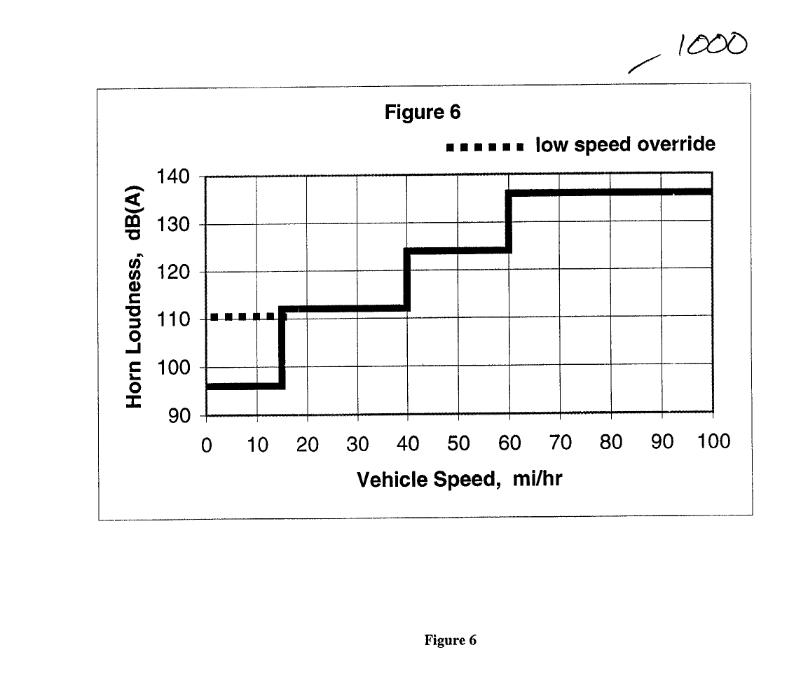

FIG. 6 demonstrates a graph 1000 showing the operation of a further embodiment of the invention having a relationship of horn loudness to vehicle speed involving a constant horn loudness within each of four vehicle speed ranges. This would allow a finer gradation of states in a vehicle in which horns of multiple strengths could be installed.

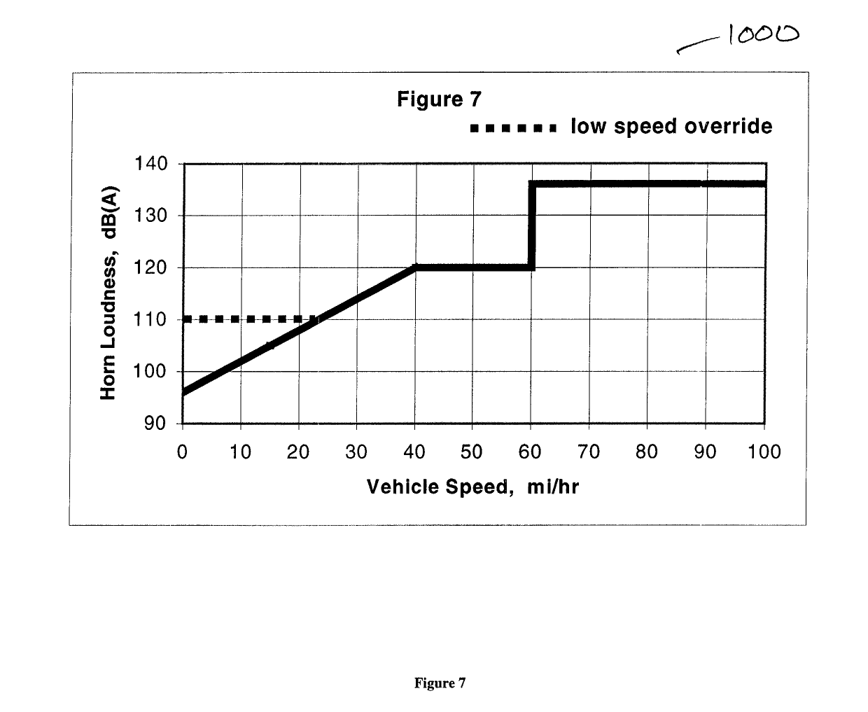

FIG. 7 illustrates a graph 1000 showing the operation of a further embodiment of the invention having a combination of features of other embodiments of the invention. In this case there is a gradual ramp-up at the slow-speed, lower loudness levels where a variable analog horn might be available, and then two discreet higher levels which might be implemented by means of dual trumpet air horns.

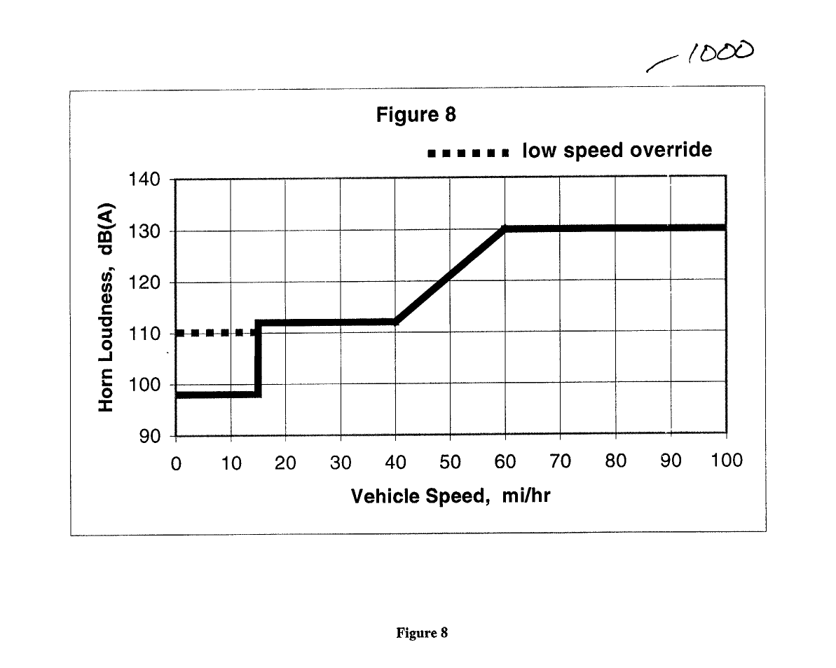

FIG. 8 illustrates a graph 1000 showing the operation of a further embodiment of the invention having a combination of features of other embodiments of the invention. This embodiment provides for the possibility of a hardware scenario where multiple small, discreet hors, perhaps of differing pitches, might be installed for the lower levels with one high capacity horn, variable by means of current or air, for the higher levels.

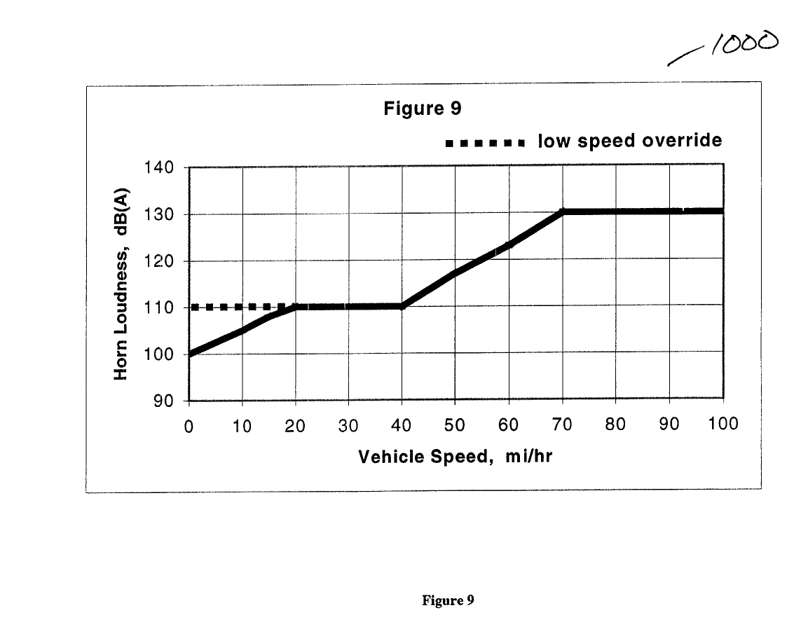

FIG. 9 illustrates a graph 1000 showing the operation of a further embodiment of the invention having a combination of features of other embodiments of the invention. This embodiment provides a gradual increase at slow speeds, maintains the typical 110 dB(A) level at moderate driving speeds, and then increases loudness at higher speeds where warning at greater distances are required.

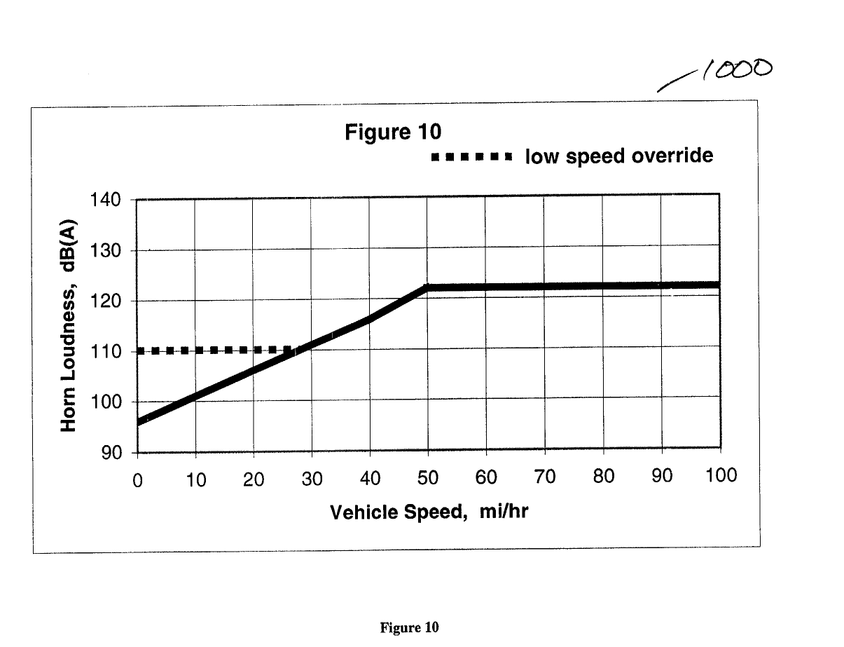

FIG. 10 illustrates a graph 1000 showing the operation of a further embodiment of the invention having a combination of features of other embodiments of the invention. This embodiment could apply to a small car situation where only a single, variable horn was available, perhaps of limited loudness. The approach would be to maintain reasonably mild levels at slow speed and ramp up to the horn's maximum at typical interstate highway speeds, flattening out at this maximum when no further loudness was achievable. The low speed override of FIG. 4 would still be available in this case, since the actuator sensing and full software control capabilities would always be available, even in a restricted space, at negligible marginal cost. A varied product line of vehicles could use the basic sensors and full-capability horn controller standard in all vehicles with specific horn hardware for each level of vehicle, with the specific software for each level of vehicle.

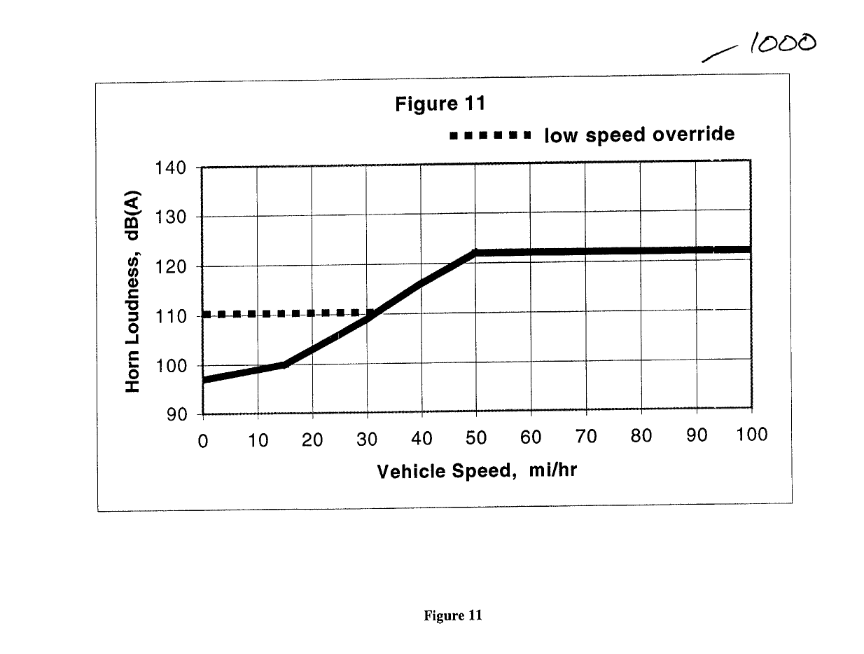

FIG. 11 illustrates a graph 1000 showing the operation of a further embodiment of the invention having a combination of features of other embodiments of the invention. This embodiment foresees the same hardware limitation as in FIG. 10, but applies two different rates at the moderate and low speeds to optimize for minimal environmental impact at low speeds. Slope breakpoints and rate steepness changes are within the scope of the invention.

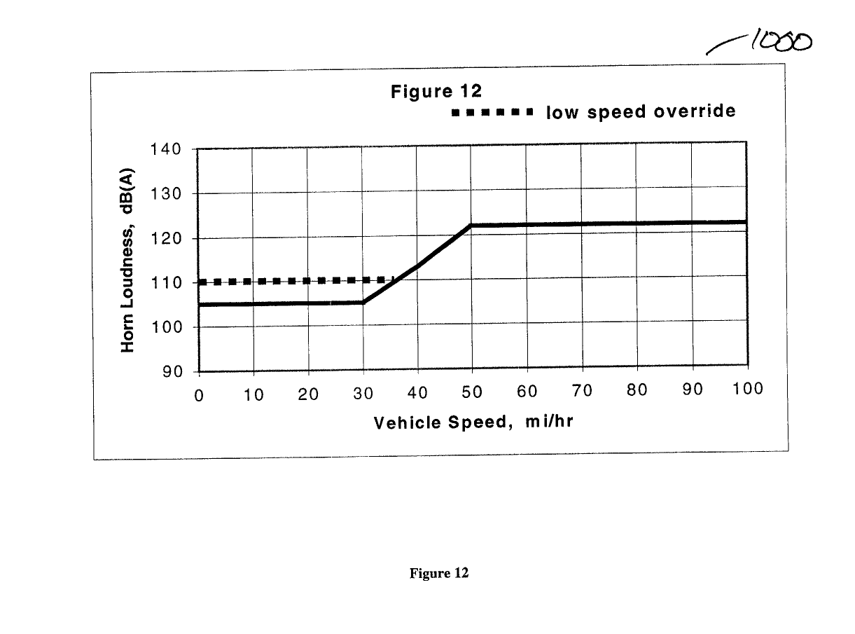

FIG. 12 illustrates a graph 1000 showing the operation of a further embodiment of the invention having a combination of features of other embodiments of the invention. This embodiment foresees the same situation as in FIG. 11, but applies a lower limit to the horn's loudness, flattening out the curve at the lowest speeds. As in the other implementations, an override based on actuation pressure or duration could be provided to produce a loudness at or above the standard 110 dB(A) in an emergency.

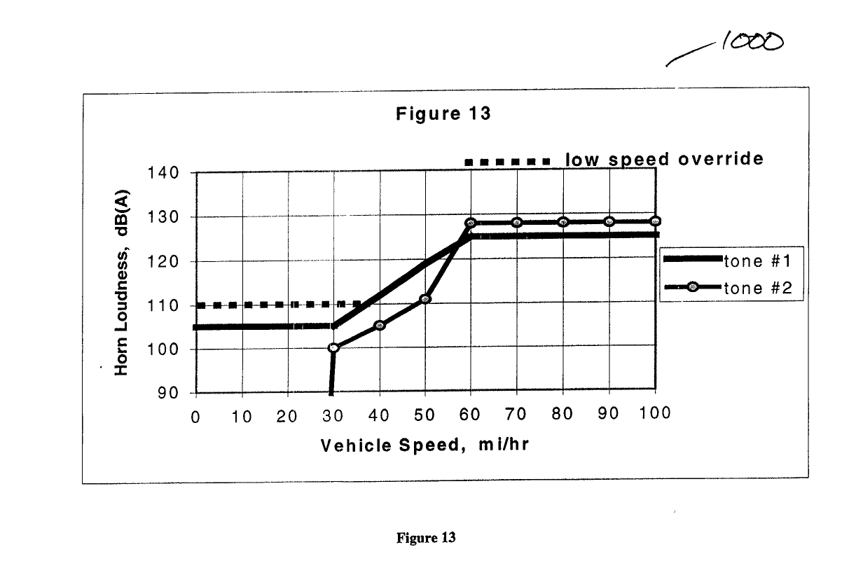

FIG. 13 illustrates a graph 1000 showing the operation of a further embodiment of the invention having a combination of features of other embodiments of the invention and including the addition of a horn at a second, dissonant tonal frequency at higher speeds. Two horns of the same loudness and tonal frequency contribute minimally to enhanced perception when sounded together, because the resulting loudness is a function of logarithmic addition, the result being an increase of only 3 dB(A) in power. While 10 dB(A) would sound like a doubling of loudness, 3 dB(A) is only a barely perceptible change in loudness. However, if the two horns are at differing and dissonant frequencies, the result can be a highly aggravating and perceptible noise. This embodiment foresees the situation when two horns of such differing frequencies are available, and the dissonant noise is introduced as a function of higher speed. In this example, the second horn with a tone close to, but annoyingly different from the tone of the first horn cuts in relatively softly at 30 mi/hr. As speed increases, the loudness of the second horn increases gradually until 50 mi/hr. Its loudness then increases at a steeper slope until it matches the first horn in loudness at 60 mi/hr. Appropriate specific frequencies to achieve suitably aggravating dissonance would be determined during engineering development.

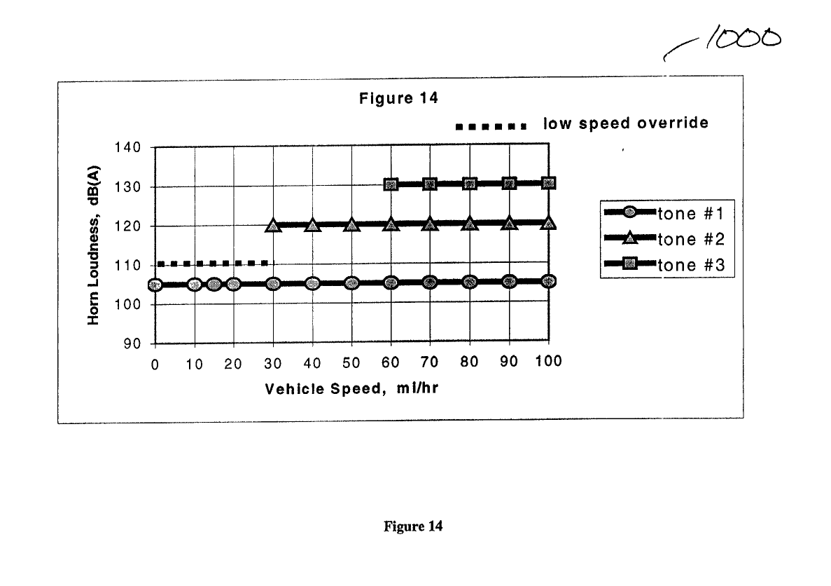

FIG. 14 illustrates a graph 1000 showing the operation of a further embodiment of the invention having a combination of features of other embodiments of the invention and including three separate horns designed to be at dissonant, aggravating tonal frequencies. In this case the implementation could be a set of triple-trumpet air horns where each horn has constant loudness, but the second horn is louder than the first, and the third horn is louder than the second. At 30 mi/hr the second horn cuts in causing a loud dissonance. At 60 mi/hr the third horn cuts in even louder, causing additional dissonance. The result at high speed is a raucous, hard-to-ignore blast.

The present invention has been described by way of example, and modifications and variations of the exemplary embodiments will suggest themselves to skilled artisans in this field without departing from the spirit of the invention. Features and characteristics of the above-described embodiments may be used in combination. The preferred embodiments are merely illustrative and should not be considered restrictive in any way.

What is claimed is:

1. An alert apparatus for use with a vehicle, comprising:
a horn capable of producing a sound;
a first sensor adapted to determine a speed of said vehicle; and
a controller coupled to said first sensor and said horn and adapted to activate said horn such that characteristics of said sound are determined based on said speed.

2. The apparatus of claim 1, further comprising:
a horn switch adapted to be operated by a force applied by an operator of said vehicle;
a second sensor adapted to determine an amount of said force; and
wherein said controller is coupled to said first sensor, said second sensor, said horn switch and said horn and adapted to activate said horn such that characteristics of said sound are determined based on said speed and said force.

3. An alert apparatus for use with a vehicle, comprising:
a horn capable of producing a sound;
a horn switch adapted to be operated by a force applied by an operator of sad vehicle;
a sensor adapted to determine an amount of said force; and
a controller coupled to said sensor, said horn switch and said horn and adapted to activate said horn such that characteristics of said sound are determined based on said force.

4. A method of operating a vehicle horn, comprising the steps of:
obtaining an output from a sensor representative of a speed of a vehicle;
processing said output by the use of a controller to determine a desired horn characteristic; and
activating said vehicle horn to produce said desired horn characteristic.

5. The method of claim 4, further comprising, before said activating step, the step of obtaining an output from a horn switch, wherein said activating step is performed in response to an output from said horn switch.
